(19) United States
(12) Patent Application Publication
(10) Pub. No.: US 2025/0342573 A1
(43) Pub. Date: Nov. 6, 2025

(54) APPARATUS AND METHOD FOR WHITEBOARD RECTIFICATION

(71) Applicant: CANON U.S.A., INC., MELVILLE, NY (US)

(72) Inventor: Peng Sun, Irvine, CA (US)

(21) Appl. No.: 18/871,672

(22) PCT Filed: Jun. 6, 2023
(86) PCT No.: PCT/US2023/024574

§ 371 Date: Dec. 4, 2024

Related U.S. Application Data
(60) Provisional application No. 63/349,777, filed on Jun. 7, 2022.

(51) Int. Cl. G06T 5/80; G06T 3/08; H04N 9/31

(52) U.S. Cl. CPC G06T 5/80; G06T 3/08; H04N 9/3185

(57) ABSTRACT

An image processing apparatus for determining the aspect of ratio of a planar rectangular region located in three dimensions is provided and is configured to capture a two-dimensional projection of the planar rectangular region located in three dimensions, determine four corners of the rectangular region in the two-dimensional projection, estimate an aspect ratio of the planar rectangular region located in three dimensions based on the four corners of the rectangular region in the two-dimensional projection, and render, via a graphical user display, a rendered rectangular form of the two-dimensional projection of the planar rectangular region located in three dimensions corrected for geometric projection distortions in a rectangular form on the graphical user display, wherein the rendered rectangular form has the estimated aspect ratio.

### CROSS REFERENCE TO RELATED APPLICATIONS

This application claims priority to U.S. Provisional Patent Application Ser. No. 63/349,777 filed on Jun. 7, 2022, the entirety of which is incorporated herein by reference.

### BACKGROUND

### Field

The disclosure relates to image processing techniques.

### Description of Related Art

In a remote meeting scenario, contents on a whiteboard are often hard to read due to factors such as perspective distortions. This primarily results from the whiteboard not being correctly imaged right from a front view due to the position of the image capture apparatus in the room. This results in the aspect ratio of the whiteboard being out of sync thus rendering the information written thereon being unreadable. One manner of correcting this this is to solve a homographic transformation by assuming a fixed aspect ratio for a given whiteboard. However, the assumption on which this is resolved is faulty and does not fully improve the visibility or readability of the information written on the whiteboard. Thus, this negatively impacts any sharing of information of people who are not in the room. A system and method according to the present disclosure remedies the drawbacks identified above.

### SUMMARY

A system and method for quickly and accurately identifying the correct aspect ratio of a planar surface is provided. This advantageously removes this distortion and shows the whiteboard as if it is imaged from the front improves the readability of the whiteboard's content.

In an embodiment of the present disclosure, an image processing apparatus and method for determining the aspect of ratio of a planar rectangular region located in three dimensions is provided and includes one or more processors and one or more memories storing instructions that, when executed, configures the one or more processors, capture (or otherwise obtain) a two-dimensional projection of the planar rectangular region located in three dimensions, determine four corners of the rectangular region in the two-dimensional projection, estimate an aspect ratio of the planar rectangular region located in three dimensions based on the four corners of the rectangular region in the two-dimensional projection, and render, via a graphical user display, a rendered rectangular form of the two-dimensional projection of the planar rectangular region located in three dimensions corrected for geometric projection distortions in a rectangular form on the graphical user display, wherein the rendered rectangular form has the estimated aspect ratio.

In another embodiment, a method and apparatus for determining an aspect of ratio of a region in an image is provided and includes obtaining, from an image, a two-dimensional projection of a region having a predetermined shape located in three dimensions, the predetermined shaped region being geometrically distorted, determining a first set of points in the image that identifies a boundary of the predetermined shaped region, estimating an aspect ratio of the predetermined shaped region located in three dimensions based on the determined first set of points indicative of the boundary of the predetermined shaped region in the two-dimensional projection, and rendering, on a display device, a corrected predetermined shape region that corrects the geometric projection distortions using the estimated aspect ratio.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates an operational environment where the rectification algorithm is used to correct distortions of a planar surface.

FIG. 2 is a flow diagram detailing the operation of the rectification algorithm.

FIG. 3 illustrates a captured 2D image projected onto an image plane.

FIG. 4. Illustrates the image plane in FIG. 3 redrawn from a different perspective.

FIG. 5A & 5B illustrates FIG. 2 redrawn such that the optic center is positioned at the top.

FIG. 6A illustrate an exemplary captured image surface.

FIG. 6B illustrates a rectified image of the image captured in FIG. 6A.

FIG. 7 illustrates a modification to the image plane of FIG. 4.

FIG. 8 illustrates a pin hold camera model.

FIGS. 9A & 9B illustrate an aspect ratio estimation using foreshortening.

FIG. 10 is a hardware block diagram.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

In an online meeting environment where a writing surface such as a whiteboard is being utilized by one or more participants in a meeting room, it is important that those attending the meeting remotely, and thus online, are able to clearly visualize the information being written on the writing surface. However, when captured by a camera, the content on a whiteboard is subject to the perspective distortion due to projective transformation. Existing solutions are adopted from the classic approach based on homographic transformation which assumes an aspect ratio of the rectangular shape of the whiteboard. However, a whiteboard in real life comes at a wide range of aspect ratios that are unknown to the software performing the rectification. Inaccurate aspect ratios, whether assumed or estimated, lead to poorly synthesized frontal views of the whiteboard and the content on it, thus resulting in poor user experience.

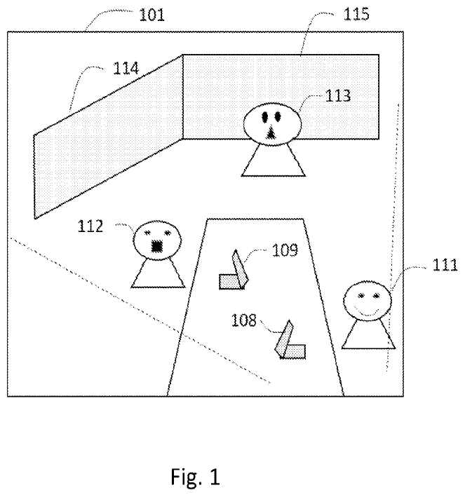

FIG. 1 shown below illustrates an exemplary environment from where an online meeting can originate. The meeting room 101 is shown having a plurality of users 111, 112 and 113 present therein. Users 112 and 113 are shown at a meeting table using computing devices 109 and 108, respectively. The computing devices 109 and 108 may be laptop computers. However, this is shown for purposes of example only and any computing device such as a tablet or smartphone may be used. The meeting room 101 further includes a first writing surface 114 and a second writing surface 115. In one embodiment, the writing surface is a whiteboard where information can be written or drawn thereon. In another embodiment, the wiring surface may be a poster board whereby object or items can be pinned or otherwise secured thereto. In further embodiments, a combination of whiteboard and poster boards may be present in meeting room 101. Further, as illustrated in FIG. 1, user 113 is a presenting user and is standing in front of the second writing surface 115. An image capture apparatus, such as a camera (not shown), is present in meeting room 101 and can selectively capture a field of view of the meeting room and the users and writing surfaces therein. An exemplary field of view of an image capture apparatus is illustrated by the dashed lines in FIG. 1. This field of view may be captured from a frontal angle or from a top down angle due to the camera being mounted, for example, in an corner of a room. As this single camera captures the defined field of view, and due to its positioning, one or both of the writing surfaces 114 and 115 may not be captured from a frontal view thereby resulting in distortion when shared to users remotely logging into the meeting that is ongoing from meeting room 101. The field of view illustrated in FIG. 1 is shown for purposes of example only and intended to illustrate the problem resolved by the present disclosure. In operation, the field of view may be captured from any location whereby the camera is mounted to try to capture as much of the meeting room as possible including the users, the writing surfaces and/or any objection therein so that these items can be shared to users logging in remotely to the online meeting.

As will be discussed below, the rectification algorithm of the present disclosure does not need to know the actual aspect ratio of either surfaces 114 or 115 in order to properly correct the distortion caused due to camera placement and capture thereof. The presently described rectification algorithm advantageously finds an analytical solution for the aspect ratio of a whiteboard's rectangular shape given the four corner locations on an image captured by a camera. The rectification algorithm according to the present disclosure advantageously solves the homographic transformation needed to correct the aspect ratio without information such as, for example, camera focal length and 2D projections of lines that are perpendicular to the plane of the rectangle. As such, the presently described algorithm is more flexible and can be used in a myriad of different locations and different camera positions at the location.

The present disclosure describes a rectification algorithm for a writing surface such as a whiteboard, but it should be clear to the reader that this disclosure is not limited to whiteboards. The algorithm can correct the distortion on any size and shaped surface from which predetermined boundaries can be identified. The systems, devices, and methods described herein may also pertain to other rectangular planar shapes in a 3D environment capture by 2-dimensional projective capture device such as a camera. Some examples of these types of objects are box faces, bulletin boards, sheets of paper, posters, windows, art works, pictures, frames, walls, tables, etc.

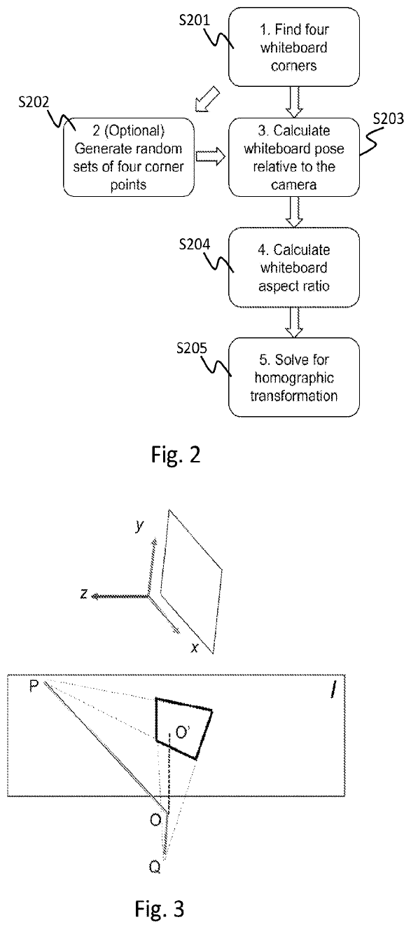

A flow diagram for the surface rectification algorithm is shown in FIG. 2 below. In step S201 of FIG. 2, a predetermined number of points along a boundary of a surface are defined. In one embodiment, the predetermined number of points is four and represent the corners of a substantially rectangular or square surface. The predetermined number of points may be defined, for example, by a user via input on a graphical user interface. In other embodiments, the predetermined number of points are automatically detected using a detection module specifically configured to location points at which two lines meet to identify each meeting point as a corner.

In a case where the predetermined number of points (e.g. corner locations) are input by a user or are automatically detected, and there is a high degree of variability, a number of second predetermined number of points are drawn around the set of first predetermined number of points in step S202. In other embodiments, third or more sets of predetermined points may be generated and used with the first set of predetermined points to improve the accuracy of surface orientation and aspect ratio. The use of a plurality of sample points surrounding each respective one of the predetermined points advantageously reduces the variability of the estimated focal length. This is particularly advantageous where the surface is turned further away from the camera's optical axis. In some embodiments, step S202 is optionally performed so once the boundary points are defined or detected in step S201, the algorithm proceeds to step S203 where the orientation of the whiteboard is estimated. As used herein, the orientation corresponds to the slant angle and tilt angle of the whiteboard relative to the camera or other imaging apparatus. The estimation is performed as described below.

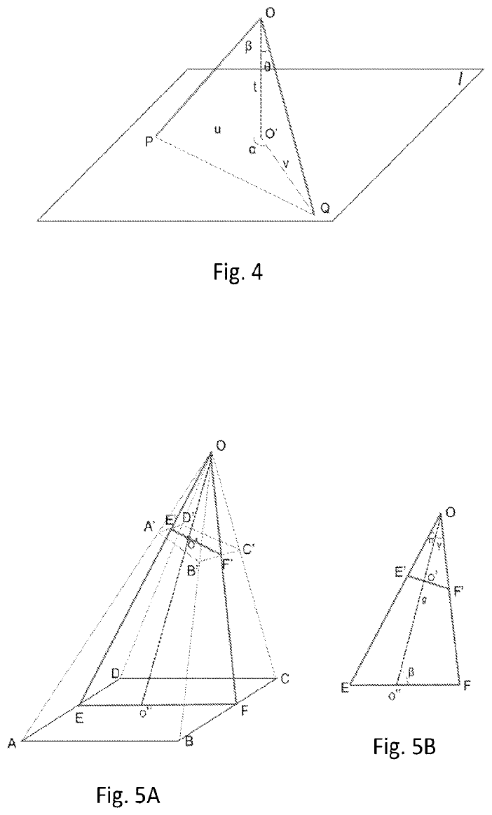

FIG. 3 below illustrates the whiteboard in the 3D world is projected onto the image plane I, via the optic center O (the camera lens). The optic axis intersects with the image plane at the point O′. Due to perspective projection, parallel sides of the rectangle are no longer parallel on the image. Rather, they intersect at points P and Q respectively. These points are called vanishing points. An important fact about the two vanishing points is that the line linking the optic center O and each vanishing point is parallel to the respective set of parallel lines in 3D. That is, the line OP and OQ are parallel to the x and y axis respectively. Given the projected four corner locations A′, B′, C′, D′ (see FIG. 5A) in the image, the algorithm identifies the angles subtended by OO′ and OP, and by OO′ and OQ as shown in FIG. 4.

The above description can be further visualized in FIG. 4 below which is a redrawn version of FIG. 3. As can be seen in FIG. 4, the angle between OP and OO′ is denoted as β, the angle between OQ and OO′ as θ, the angle between O′P and O′Q as α. Also the length of O′P is designated as u, the length of O′Q is designated as v, and the length of OO′ is designated by t. In Equations 1-6, a formula for the angles of the camera relative to the whiteboard plane, β and θ is derived. First, by cosine theorem, we have equation which recites:

$${\vert PQ \vert}^{2} = {u}^{2} + {v}^{2} - 2 u v * cos α \qquad ( 1 )$$

where |PQ| is the distance between the two vanishing points P and Q. Therefore, because the optic axis OO′ is perpendicular to the image plane I shown in FIG. 4, we get the following in Equation 2:

$$\vert OP {\vert}^{2} = {u}^{2} + {t}^{2} , \vert OQ {\vert}^{2} = {v}^{2} + {t}^{2} \qquad ( 2 )$$

Since OP and OQ are parallel to the rectangular shape of the whiteboard (see FIG. 3), they are orthogonal to each other which is written in Equation 3 as:

$$\vert PQ {\vert}^{2} = \vert OP {\vert}^{2} + \vert OQ {\vert}^{2} \qquad ( 3 )$$

Substituting Eq. 3 with Eq. 1 and 2 gives:

$${u}^{2} + {v}^{2} - 2 u v * cos α = {u}^{2} + {v}^{2} + 2 {t}^{2} \qquad ( 4 )$$

From Eq. 4, one can obtain:

$$t = \sqrt{- uv * cos α} \qquad ( 5 )$$

With Eq. 5, β and θ can be obtained:

$$tan β = u / \sqrt{- uv * cos α ,} tan θ = v / \sqrt{- uv * cos α} \qquad ( 6 )$$

Through these equations, the camera's focal length t can be obtained (Eq. 5). Then the pose angles of the whiteboard β and θ can be derived (Eq. 6). The pose angle represent the rotation of the whiteboard relative to the camera. From there, the aspect ratio of the shape of the surface is estimated as follows and is better understood when viewing a redrawn version of FIG. 3 illustrated in FIGS. 5A & 5B. If you rotate the rectangle in front of camera, t

In FIG. 5A, the optic center O is shown on the top. The rectangular whiteboard is represented as ABCD whose projection on the image plane is A′B′C′D′. The optic axis intersects with the image plane at O′ and with the whiteboard plane at O″. The line EF is a line parallel to AB and CD and through O″ with intersections with AD at E, and with BC at F. Due to perspective projection, the image of E and F falls on A′D′ and B′C′ respectively. O′ is on E′F′ because O′ is the image of O″. An important observation is that the line E′F′, which also contains O′, must go through the vanishing point of A′B′ and C′D′. This is because EF is parallel to AB and CD, and the image of parallel lines must intersect at a single vanishing point on the image plane.

With the set up illustrated in FIG. 5A, one can readily derive the aspect ratio, that is, |AB|/|CD|. FIG. 5B illustrates, the triangle OEF and is shown for purposes of clarity. Note that the angle between OO″ and O″F is β that is already derived in Eq. (3) above. In Equations 7-11, the aspect ratio of the two sides of the rectangle will be determined. The distance between O and O″ is designated to be g, then by the sine theorem, the length |O″F| is given by:

$$\vert {O}^{″} F \vert = \frac{g}{sin ( γ + β )} sin γ \qquad ( 7 )$$

Similarly, the length |O″E| is given by:

$$\vert {O}^{′′} E \vert = \frac{g}{sin ( β - π )} sin π \qquad ( 8 )$$

Therefore, the length of one side of the rectangle, |AB|,is given by:

$$\vert AB \vert = \vert EF \vert = \vert {O}^{′′} F \vert + \vert {O}^{′′} E \vert = g ( \frac{sin γ}{sin ( γ + β )} + \frac{sin π}{sin ( β - π )} ) \qquad ( 9 )$$

One can repeat the steps above to draw a triangle through O and the line through O″ and parallel to AD and BC. Following similar procedures, the length |AD| is determined as follows:

$$\vert AD \vert = g ( \frac{sin φ}{sin ( φ + θ )} + \frac{sin ω}{sin ( θ - ω )} ) \qquad ( 10 )$$

where θ is given in E.q. (6), φ, ω are angles equivalent to π, γ in FIG. 5B. Although not shown, the obtain the length of AD, a further triangle similar to OEF is included and angles φ, ω would be the same as π, γ. Note that Eq 10 and 11 share a common factor g that will be canceled through division. From Eq. (9) and (10), we have:

$$\frac{\vert AB \vert}{\vert CD \vert} = ( \frac{sin γ}{sin ( γ + β )} + \frac{sin π}{sin ( π + β )} ) / ( \frac{sin φ}{sin ( φ + θ )} + \frac{sin ω}{sin ( θ - ω )} ) \qquad ( 11 )$$

Thereafter, the values of the angles φ, ω and π, γ can be determined using Equations 12-15 below. The calculation is based on the homogeneous coordinate system, therefore intersections of lines, and lines connecting two points can be conveniently calculated through cross products of homogeneous coordinates. More specifically, P_{A′}=(x_{A′}, y_{A′}, 1)^{T} is the homogeneous coordinate of A′ on the image plane where (x_{A′}, y_{A′}) and represents the location of corner A′ in pixels. In the same manner, p_{B′}, P_{c}′, P_{D′} can be defined for corner B′, C′ and D′, respectively. Angles π, γ, can be determined using only |O′E′| and |O′F′|, because |OO′|=t is already given by E.q. (5). Therefore determining π, γ requires knowing P_{E′}=(x_{E′}, y_{E′}, 1)^{T} and p_{F′}=(x_{F′}, y_{F′}, 1)^{T}. l_{A′B′}=(a b c)^{T} represents the line going through A′ and B′ and l_{C′D′} represents the line going through C′ and D′. Then l_{A′B′} is obtained by taking the cross product of p_{A′} and p_{B′}:

$${l}_{{A}^{′} {B}^{′}} = {p}_{{A}^{′}} \times {p}_{{B}^{′}} , {l}_{{C}^{′} {D}^{′}} = {p}_{{C}^{′}} \times {p}_{{D}^{′}} \qquad ( 12 )$$

The intersection of l_{A′B′} and l_{C′D′}, i.e. their vanishing point P is given by:

$${p}_{P} = {l}_{{A}^{′} {B}^{′}} \times {l}_{{C}^{′} {D}^{′}} \qquad ( 13 )$$

Then the line connecting O′ and the vanishing point P is:

$${l}_{{O}^{′} P} = {p}_{{O}^{′}} \times {p}_{P} \qquad ( 14 )$$

Applying the same principle, p_{E′} and p_{F′} can be obtained by taking the cross product of l_{O′P} with l_{A′D}′ and l_{C′B′}:

$${p}_{{E}^{′}} = {l}_{{O}^{′} P} \times {l}_{{A}^{′} {D}^{′}} , {p}_{{F}^{′}} = {l}_{{O}^{′} P} \times {l}_{{B}^{′} {C}^{′}} \qquad ( 15 )$$

With the location of E′ and F′ resolved, angles π, γ can be obtained, and in the same way φ, ω can be obtained too. As such, the algorithm according to the present disclosure computes the aspect ratio

$$\frac{\vert AB \vert}{\vert CD \vert}$$

using Eq. 11.

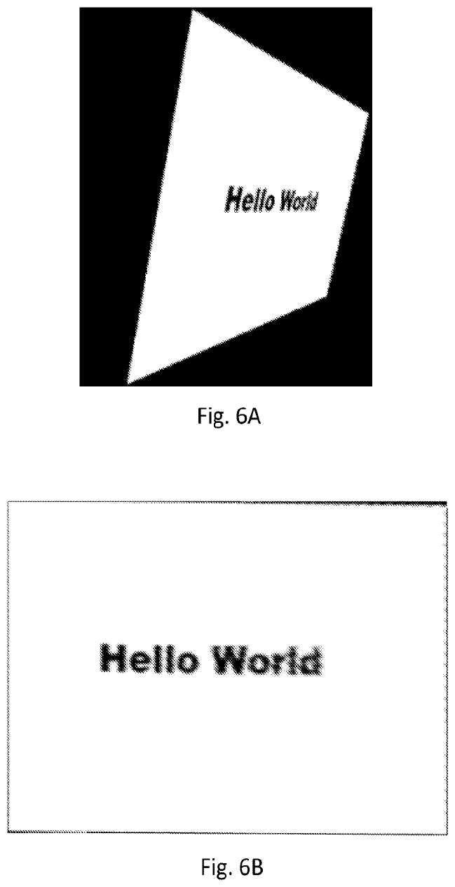

Returning back to FIG. 2, in step S205, once the aspect ratio has been determined for the first set of predetermined points, Equation (11) is used to compute the aspect ratio for every sample set of the predetermined points (e.g. corner locations). The average of these sets is obtained as the final estimate for the aspect ratio which is then used to perform the homographic transformation. The above algorithm advantageously uses the estimated aspect ratio which is determined in real time with reference to the specific image capture device. As such, the resulting transformation provides a significantly improved rectified whiteboard image as can be seen in FIG. 6A which represents an exemplary skewed, uncorrected image captured by an image capture device and FIG. 6B which illustrates the corrected image after being processed by the rectification algorithm described herein.

FIG. 6A illustrates an original image captured by a camera at a predetermined location in a meeting room. When the rectification algorithm described above is executed, the resulting, rectified image used for provision to remote users is shown in FIG. 6B. As can be seen, the original image in FIG. 6A has a first aspect ratio that was captured from a non-front capture is skewed. But, after undergoing rectification processing described herein, FIG. 6B generates an image with the correct aspect ratio which corrects the image to its actual aspect ratio as if the surface was imaged from the front. This improves the images used in transmission to remote meeting participants and improves the overall quality of the meeting so that all users are seeing the same surface and information written thereon.

The algorithm described above is based on 3D geometries of the camera imaging model. The problem setup illustrated in FIGS. 3-5A/5B corresponds to a situation in which the center of the image is inside the quadrilateral projection of the rectangular whiteboard. However, if the image center is outside of the quadrilateral, either to the left or right, above or below, the plus signs in Eq. 11 may have to flip to minus signs, depending on whether the whiteboard plane's angle relative to the camera (e.g. the sign of β and θ in FIG. 4). One could check which of the 16 conditions (i.e. 2(±β)×2(±θ)×2(O′ left, O′ right)×2()′ above, O′ below)), and set the sign accordingly. The first embodiment only deals with the case in which both β and θ are positive, optic center O′ is inside the projected rectangle. Let's call this condition 1. However, β could be negative. If β0 is negative but everything else remains same as condition 1, then we have a new condition. Let's call this condition 2. Some of the equations derived above need to adjust corresponding signs for condition 2. Similarly we have to deal with new conditions as θ changes signs, as O′ changes positions (left, right, below, above the projected shape). All together, adjustments are needed for all the possible 16.

In an additional embodiment, further processing can be performed to estimate the aspect ratio of the whiteboard. A second embodiment, is built up on the first embodiment described above and represents a geometry-based method. The third embodiment, is based on the first but removes the geometric element of the second embodiment.

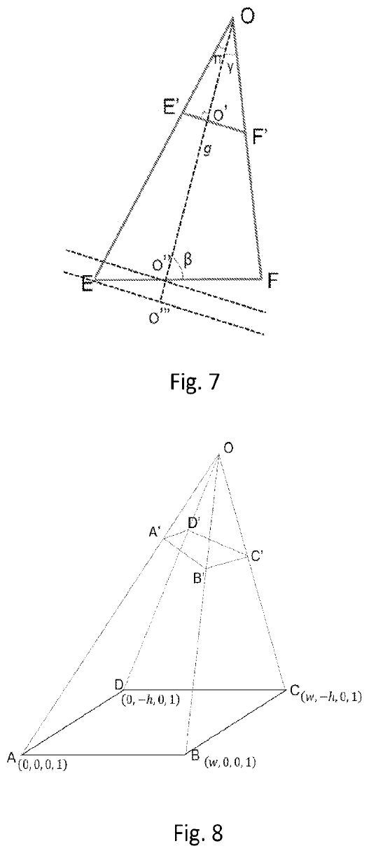

In the second embodiment, the sign confusion in Eq. 11 can be remedied by rewriting the length equation with matrix algebraic formula. FIG. 7 shows the same triangle in FIG. 5B with two parallel lines added to indicate the plane parallel to the image plane. The intersection of the optic center and one of the added planes is annotated as O′″. The length of OO′″ is λ_{E}. Which is the depth coordinate of point E in the world coordinate system. O″ is the origin of the world coordinate system, and P_{E′}=(x_{E′}, y_{E′}, 1)^{T} is the coordinate of the point E′ on the image. p_{F′}=(x_{F′}, y_{F′}, 1)^{T} represents the coordinate of the point F′ on the image. p_{E′} represent the coordinate of a point E′, and x_{E′}, y_{E′} are the coordinate's x and y components respectively. Similarly p_{F′} represent the coordinate of a point F′. x_{F′}, y_{F′} are the coordinate's x and y components. Using a pin hole camera model, the position of the point E on the whiteboard plane relative to the world origin O″ is calculated as:

$${λ}_{E} {p}_{E} ′ = {CMp}_{E} \qquad ( 16 )$$

where p_{E}=(x_{E}, 0, 0, 1)^{T} is the point E in the world coordinate system, Cis the camera matrix, and M=[r₁ r₂ r₃ t] is the rotation matrix. Expanding Eq. 16 yields

$${λ}_{E} {p}_{{E}^{′}} = {Cr}_{1} {x}_{E} + C t \qquad ( 17 )$$

Similarly, we can also calculate the position of point F as:

$${λ}_{F} {p}_{{F}^{′}} = {Cr}_{1} {x}_{F} + C t \qquad ( 18 )$$

Subtracting Eq. 17 from Eq. 18 gives

$${λ}_{F} {p}_{{F}^{′}} - {λ}_{E} {p}_{{E}^{′}} = {Cr}_{1} ( {x}_{F} - {x}_{E} ) \qquad ( 19 )$$

which further yields

$${( {x}_{F} - {x}_{E} )}^{- 1} {C}^{- 1} ( {λ}_{F} {p}_{{F}^{′}} - {λ}_{E} {p}_{{E}^{′}} ) = {r}_{1} \qquad ( 20 )$$

Note that (x_{F}-x_{E}) is the signed width of the whiteboard, and let it be ±w. Taking the dot product on each side yields

$${{w}^{- 2} ( {λ}_{F} {p}_{F r} ′ - {λ}_{E} {p}_{E} ′ )}^{T} {C}^{- T} {C}^{- 1} ( {λ}_{F} {p}_{F r} ′ - {λ}_{E} {p}_{E} ′ ) = 1 \qquad ( 21 )$$

Similarly for the other triangle, which intersects with triangle OEF at OO″ we have

$${{h}^{- 2} ( {λ}_{H} {p}_{H} , - {λ}_{I} {p}_{I} , )}^{T} {C}^{- T} {C}^{- 1} ( {λ}_{H} {p}_{H} , - {λ}_{I} {p}_{I} , ) = 1 \qquad ( 22 )$$

Now a common factor among λ_{F},λ_{E}, λ_{H}, λ_{I} is determined and divides Eq. 21 by E.q. 22 to obtain w/h. This common factor is |OO|=g, similar to how the same common factor is canceled in the first geometric method. Note that λ_{F},λ_{E}, λ_{H}, λ_{I} are the depth coordinates therefore have the same sign as λ_{O″}=±g, so we no longer have sign confusions. These steps enable derivation of common factors among λ_{F},λ_{E}, λ_{H}, λ_{I} which are the z coordinates of those vanishing points in the 3D world, that is, their distance away from the camera. With the common factor found, the aspect ratio can be obtained by dividing one of the lambdas by another.
From the triangle O″EO′″ in FIG. 7, we have

$$\vec{O {}^{′} O} = \vert O \text{"} E \text{\textbar sinβ} \qquad ( 23 )$$

where |O″E| is given by E.q. 8 and is a multiple of g. Note that \vec{O′″O″} can take a minus sign, depending on the angle β, that is, which way the whiteboard plane is tilted toward the camera. Taken together, we have

$${λ}_{E} = \vert OO |=| O O \vert + \vert O \text{"} E \text{\textbar sinβ=g+} \frac{sin π sin β}{sin ( β - π )} g \qquad ( 24 )$$

Following the same procedure, we have

$${λ}_{F} = g + \frac{sin γ sin β}{sin ( γ + β )} g , {λ}_{H} = g + \frac{sin φ sin θ}{sin ( φ + θ )} g , {λ}_{I} = g + \frac{sin ω sin θ}{sin ( θ - ω )} g \qquad ( 25 )$$

Geometrically, λ_{F} λ_{E} can be obtained by adding their corresponding segments together, illustrated in FIG. 7. In Eq. 24 and 25, those segments (OO″, O″E, O″F) are written out. Note that in Eq. 25, λ_{H}λ_{I} that correspond to O″H, O″I are also given. O″H and O″I are line segments in the triangle OHI that is equivalent to OEF, but is not drawn. As such, λ_{F} λ_{E} λ_{H}λ_{I} are equivalent and obtaining the equation of one leads to obtaining it for all. Then, by dividing Eq. 21 by Eq. 22, we can obtain the aspect ratio of the captured image:

$${w}^{2} / {h}^{2} = {( {λ}_{F} {p}_{F} , - {λ}_{E} {p}_{E} , )}^{T} {C}^{- T} {C}^{- 1} ( {λ}_{F} {p}_{F} , - {λ}_{E} {p}_{E} , ) / {( {λ}_{H} {p}_{H} , - {λ}_{I} {p}_{I} , )}^{T} {C}^{- T} {C}^{- 1} ( {λ}_{H} {p}_{H} , - {λ}_{I} {p}_{I} , )$$

where λ_{F},λ_{E}, λ_{H}, λ_{I} are given by Eq. 24 and Eq. 25. The results of which are then input to step S205 of FIG. 2 so that the homographic transformation can be computed to generate the corrected, rectified image.

A third embodiment is provided and is based on an aspect of the second embodiment relating to the identification of a common factor among the analytical forms of the width and height indicating that the aspect ratio can then be obtained. The analytical forms of the width and height do not have to be related to the geometric properties of the vanishing points as described in the first and second embodiments. In fact, using the four corner points of the rectangle directly results in the rectification algorithm that reduces variabilities caused by computing the vanishing points while sacrificing its geometric interpretation therefore being less intuitive. The third embodiment is described with respect to FIG. 8 below.

FIG. 8 is a pinhole camera model having optic center O, the rectangular whiteboard ABCD and its projection A′B′C′D on the image plane. Similar to Method 2, we set up the problem with a pin hole camera model (FIG. 6). We first obtain the analytical form for the whiteboard width w and height h respectively. Without losing generality, let one of the whiteboard's four corners A be the origin of the world coordinate system, then for p_{A}=(0, 0, 0, 1)^{T} the coordinate of point A, we have

$${λ}_{A} {p}_{A} , = {CMp}_{A} \qquad ( 26 )$$

where C is the camera matrix, M=[r₁ r₂ r₃ t] is the rotation matrix. Expanding E.q. 26 yields

$${λ}_{A} {p}_{A} , = Ct \qquad ( 27 )$$

For the other three points B, C, D as illustrated in FIG. 8, we have

$${λ}_{B} {p}_{B} , = C t + C w {r}_{1} , {λ}_{C} {p}_{C} , = C t + C w {r}_{1} - C h {r}_{2} , {λ}_{D} {p}_{D} , = C t - C h {r}_{2} \qquad ( 28 )$$

From Eq. 28 and 27, one can obtain w and h:

$${C}^{- 1} {w}^{- 1} ( {λ}_{B} {p}_{B} , - {λ}_{A} {p}_{A} , ) = {r}_{1} , {C}^{- 1} {h}^{- 1} ( - {λ}_{D} {p}_{D} , + {λ}_{A} {p}_{A} , ) = {r}_{2} \qquad ( 29 )$$

Taking dot product on both sides of the two equations in Eq. 29 yields

$${{w}^{- z} ( {λ}_{B} {p}_{B} , - {λ}_{A} {p}_{A} , )}^{T} {C}^{- τ} {C}^{- 1} ( {λ}_{B} {p}_{B} , - {λ}_{A} {p}_{A} , ) = 1 \qquad ( 30 )$$

$${{h}^{- 2} ( - {λ}_{D} {p}_{D} , + {λ}_{A} {p}_{A} , )}^{T} {C}^{- T} {C}^{- 1} ( - {λ}_{D} {p}_{D} , + {λ}_{A} {p}_{A} , ) = 1 \qquad ( 31 )$$

This results in a similar issue that occurs in the second embodiment whereby common factor among λ_{A}, λ_{B}, λ_{D} are obtained. One solution is to consider λ_{B}, λ_{D} in terms of multiples of λ_{A} which can be done without referring to geometry such that, in view of Eq. 27 and Eq. 28, Eq. 32 is derived

$${λ}_{C} {p}_{C} , + {λ}_{A} {p}_{A} , = {λ}_{B} {p}_{B} , + {λ}_{D} {p}_{D} , \qquad ( 32 )$$

Next, processing occurs to derive λ_{B} and λ_{D} as multiples of λ_{A}. First λ_{C} is removed from Eq. 32 by taking a cross product with p_{C}, on each side which produces

$${λ}_{A} {P}_{A} , \times {p}_{C} , = {λ}_{B} {p}_{B} , \times {p}_{C} , + {λ}_{D} {p}_{D} , \times {p}_{C} , \qquad ( 33 )$$

Then taking dot product with p_{D}, on each side, thus removing λ_{D} yields Eq. 34 as follows:

$${λ}_{A} ( {P}_{A} , \times {p}_{C} , ) \cdot {P}_{D} , = {λ}_{B} ( {p}_{B} , \times {p}_{C} , ) \cdot {p}_{D} , = > {λ}_{B} = \frac{( {p}_{A} , \times {p}_{C} , ) {p}_{D} ,}{( {p}_{B} , \times {p}_{C} , ) {p}_{D} ,} {λ}_{A} \qquad ( 34 )$$

Taking dot product with p_{B}, on each side, thus removing λ_{B} yields Eq. 35

$${λ}_{D} = \frac{( {P}_{A} , \times {p}_{C} , ) {p}_{B} ,}{( {p}_{D} , \times {p}_{C} , ) \cdot {p}_{B} ,} {λ}_{A} \qquad ( 35 )$$

Substituting Eq. 35 and 34 into Eq. 30 and Eq. 31 and divide them up will yield:

$${w}^{2} / {h}^{2} = \frac{{( \frac{( {p}_{A} , \times {p}_{C} , ) \cdot {p}_{D} ,}{( {p}_{B} , \times {p}_{C} , ) \cdot {p}_{D} ,} {p}_{B} , - {p}_{A} , )}^{T} {C}^{- T} {C}^{- 1} ( \frac{( {p}_{A} , \times {p}_{C} , ) \cdot {p}_{D} ,}{( {p}_{B} , \times {p}_{C} , ) \cdot {p}_{D} ,} {p}_{B} , - {p}_{A} , )}{{( \frac{( {p}_{A} , \times {p}_{C} , ) \cdot {p}_{B} ,}{( {p}_{D} , \times {p}_{C} , ) \cdot {p}_{B} ,} {p}_{D} , - {p}_{A} , )}^{T} {C}^{- T} {C}^{- 1} ( \frac{( {p}_{A} , \times {p}_{C} , ) \cdot {p}_{B} ,}{( {p}_{D} , \times {p}_{C} , ) \cdot {p}_{B} ,} {p}_{D} , - {p}_{A} , )} \qquad ( 36 )$$

Eq. 36 concludes the derivation, the result of which is the estimated aspect ratio (squared) of the surface being imaged.

All three embodiments rely on the estimation of focal length which is given by Eq. 5. As the whiteboard turns closer to the frontal view, such estimation becomes less reliable because the estimated vanishing points become more noisy. This can be visualized when considering an extreme case where two sides of the quadrilateral are perfectly parallel causing the vanishing points not to exist. Although in practice perfect parallelism does not exist and one can always find vanishing point, the estimated vanishing points in near parallelism have extremely large variance therefore very prone to noise. This variability in turn renders the estimated focal length effectively useless. These drawbacks can be further overcome by taking the average of several samples of the corner locations in the image. This is step S202 in FIG. 2, which is an optional step but useful for reducing noise in the corner locations. This could be the average of the estimated corner locations every so many frames. Once focal length is estimated, it should be fixed for the particular camera in the particular space that is capturing images of the writing surface and used throughout the entire process without further averaging/sampling required. These values are stored in a memory and called upon during each aspect ratio correction processing thereby reducing computing resources needed to rectify the image. In some embodiments, focal length may be selectively provided via firmware associated with the image capture apparatus.

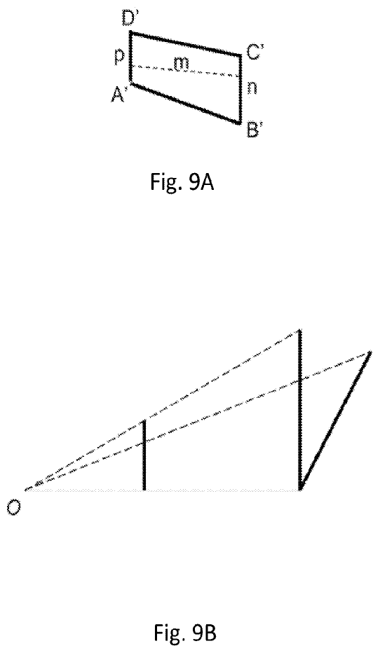

Further, it is useful to set a threshold to check for parallelism. For example, one could take the cross product of two sides of the quadrilateral which gives the sine of the angle subtended by such two sides. If the sine value is extremely small, then we say the two sides are parallel. If both pairs of sides are near parallel, then the ratio between two adjacent side is a very close approximation of the true aspect ratio. If only one pair of sides are below the threshold set for parallelism but the other pair are not, then the aspect ratio can be obtained through the concept of foreshortening as shown in FIG. 9 which illustrates estimating the aspect ratio by foreshortening

FIG. 9A shows an example in which an image of a rectangle has only one pair of parallel sides. The ratio of the two parallel side depends on the angle that the rectangle is rotated relative to the camera as shown in FIG. 9B. In FIG. 9A, this ratio is given by p/n. Note that the distance between the two parallel sides, m, is a constant that only depends on this rotation angle. Had the rectangle not rotated, the distance should have been m*n/p, and the length of the parallel side should both have been n. Therefore the aspect ratio in this case is just m/p.

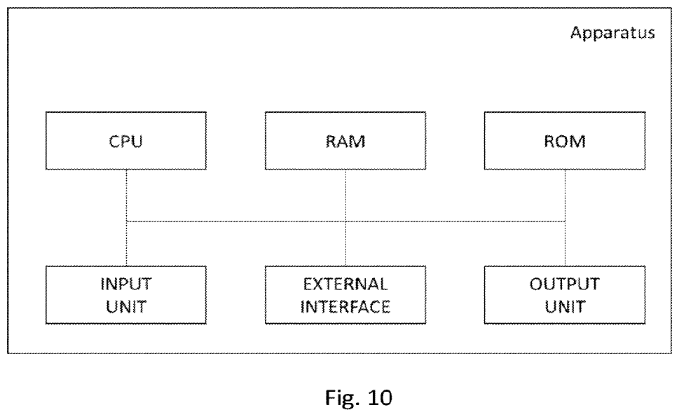

FIG. 10 illustrates the hardware that represents the image processing apparatus (e.g. control apparatus 110) used in implementing the above described disclosure. The apparatus includes a CPU, a RAM, a ROM, an input unit, an external interface, and an output unit. The CPU 401 controls the apparatus by using a computer program (one or more series of stored instructions executable by the CPU) and data stored in the RAM or ROM. Here, the apparatus may include one or more dedicated hardware or a graphics processing unit (GPU), which is different from the CPU, and the GPU or the dedicated hardware may perform a part of the processes by the CPU. As an example of the dedicated hardware, there are an application specific integrated circuit (ASIC), a field-programmable gate array (FPGA), and a digital signal processor (DSP), and the like. The RAM temporarily stores the computer program or data read from the ROM, data supplied from outside via the external interface, and the like. The ROM stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The image processing apparatus illustrated in FIG. 10 is configured to perform an image processing algorithm that rectifies the aspect ratio of a geometrically distorted region in a captured image caused by the region not being directly in from of the image capture apparatus that has captured the image. The image processing apparatus is configured to obtain, from an image, a two-dimensional projection of a region having a predetermined shape located in three dimensions, the predetermined shaped region being geometrically distorted and determine a first set of points in the image that identifies a boundary of the predetermined shaped region. The first set of points are determined by receiving input via a user interface that identifies each point in the first set of points and/or by automatically identifying points at which two lines of the predetermined region intersect. Further, an aspect ratio of the predetermined shaped region located in three dimensions is estimated based on the determined first set of points indicative of the boundary of the predetermined shaped region in the two-dimensional projection and rendered, on a display device, in the form of a corrected predetermined shape region that corrects the geometric projection distortions using the estimated aspect ratio. This includes performing a homographic transformation of using the estimated aspect ratio; wherein the corrected predetermined shaped region is rendered after the homograph transformation is performed performing In certain embodiments, a second set of points surrounding the first set of points is determined and used for estimating the aspect ratio using both the first set of determined points and second set of determined points.

In another embodiment, the image processing apparatus is configured to determine, from the image including the predetermined shaped region, a focal length of image capture apparatus that captured the image and calculate one or more pose angles of the predetermined shaped region representing a rotation of the predetermined shaped region in the image relative to the image capture apparatus.

In another embodiment, the rectification algorithm advantageously corrects the aspect ratio where the predetermined shaped region substantially rectangular where at least two sides are not parallel and the rendered corrected shaped region corrects the geometric distortion causing the at least two sides to be substantially parallel using the estimated aspect ratio. In other words, the predetermined shape region is a planar rectangular region, and the determined first set of points identify respective corners of the planar rectangular region in the two dimensional projection and the corrected predetermined shaped region rendered is a rendered rectangular form of the two-dimensional projection of the planar rectangular region located in three dimensions corrected for geometric projection distortions in a rectangular form.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for determining an aspect of ratio of a region in an image, the method comprising:
obtaining, from an image, a two-dimensional projection of a region having a predetermined shape located in three dimensions, the predetermined shaped region being geometrically distorted;
determining a first set of points in the image that identifies a boundary of the predetermined shaped region;
estimating an aspect ratio of the predetermined shaped region located in three dimensions based on the determined first set of points indicative of the boundary of the predetermined shaped region in the two-dimensional projection; and
rendering, on a display device, a corrected predetermined shape region that corrects the geometric projection distortions using the estimated aspect ratio.

2. The method according to claim 1, further comprising:
determining, a second set of points surrounding the first set of points; and
estimating the aspect ratio using both the first set of determined points and second set of determined points.

3. The method according to claim 1, wherein the first set of points are determined by receiving input via a user interface that identifies each point in the first set of points.

4. The method according to claim 1, wherein the first set of points are determined by automatically identifying points at which two lines of the predetermined region intersect.

5. The method according to claim 1, further comprising
determining, from the image including the predetermined shaped region, a focal length of image capture apparatus that captured the image; and
calculating one or more pose angles of the predetermined shaped region representing a rotation of the predetermined shaped region in the image relative to the image capture apparatus.

6. The method according to claim 1, wherein the predetermined shaped region substantially rectangular where at least two sides are not parallel and the rendered corrected shaped region corrects the geometric distortion causing the at least two sides to be substantially parallel using the estimated aspect ratio.

7. The method according to claim 1, wherein the predetermined shape region is a planar rectangular region, and the determined first set of points identify respective corners of the planar rectangular region in the two dimensional projection.

8. The method according to claim 7, wherein rendering the corrected predetermined shaped region rendered is a rendered rectangular form of the two-dimensional projection of the planar rectangular region located in three dimensions corrected for geometric projection distortions in a rectangular form.

9. An image processing apparatus comprising:
one or more memories storing instructions thereon; and
one or more processors that, upon execution of the stored instructions, are configured to perform operations comprising:
obtaining, from an image, a two-dimensional projection of a region having a predetermined shape located in three dimensions, the predetermined shaped region being geometrically distorted;
determining a first set of points in the image that identifies a boundary of the predetermined shaped region;
estimating an aspect ratio of the predetermined shaped region located in three dimensions based on the determined first set of points indicative of the boundary of the predetermined shaped region in the two-dimensional projection; and
rendering, on a display device, a corrected predetermined shape region that corrects the geometric projection distortions using the estimated aspect ratio.

10. The image processing apparatus according to claim 9, wherein execution of the stored instructions further configures the one or more processors to perform operations comprising:
determining, a second set of points surrounding the first set of points; and
estimating the aspect ratio using both the first set of determined points and second set of determined points.

11. The image processing apparatus according to claim 9, wherein the first set of points are determined by receiving input via a user interface that identifies each point in the first set of points.

12. The image processing apparatus according to claim 9, wherein the first set of points are determined by automatically identifying points at which two lines of the predetermined region intersect.

13. The image processing apparatus according to claim 9, wherein execution of the stored instructions further configures the one or more processors to perform operations comprising:
determining, from the image including the predetermined shaped region, a focal length of image capture apparatus that captured the image; and
calculating one or more pose angles of the predetermined shaped region representing a rotation of the predetermined shaped region in the image relative to the image capture apparatus.

14. The image processing apparatus according to claim 9, wherein the predetermined shaped region substantially rectangular where at least two sides are not parallel and the rendered corrected shaped region corrects the geometric distortion causing the at least two sides to be substantially parallel using the estimated aspect ratio.

15. The image processing apparatus according to claim 9, wherein the predetermined shape region is a planar rectangular region, and the determined first set of points identify respective corners of the planar rectangular region in the two dimensional projection.

16. The image processing apparatus according to claim 15, wherein rendering the corrected predetermined shaped region rendered is a rendered rectangular form of the two-dimensional projection of the planar rectangular region located in three dimensions corrected for geometric projection distortions in a rectangular form.
